(19) United States
(12) Patent Application Publication
(10) Pub. No.: US 2026/0130397 A1
(43) Pub. Date: May 14, 2026

(54) Automated Food Patty Cooking and Assembly Apparatus

(71) Applicant: Eat Robotics, Inc., Vancouver (CA)

(72) Inventor: Thomas Andrew Braun, Vancouver (CA)

(73) Assignee: Eat Robotics, Inc., Vancouver, BC (CA)

(21) Appl. No.: 19/443,062

(22) Filed: Jan. 8, 2026

Related U.S. Application Data
(63) Continuation-in-part of application No. 18/149,118, filed on Jan. 2, 2023.

(51) Int. Cl. A23L 5/10; A23L 13/00; A23L 13/60

(52) U.S. Cl. CPC A23L 5/10; A23L 13/03; A23L 13/67; A23V 2002/00; A23V 2300/24; A23V 2300/38

(57) ABSTRACT

An automated apparatus for cooking and assembling food patties, such as burgers, enhances efficiency and safety in food preparation. Housed within a compact enclosure, it features a horizontal rotating griddle with dividers for uniform patty cooking, optimized by an AI module for timing and temperature control. Patties are stacked in a temperature-controlled dispensing module and dispensed onto the griddle, cooked, and flipped into a chute for transfer. The assembly module uses rotary carousels with multiple bun tubes for high-capacity dispensing (e.g., 180 burgers per hour), eliminating bottlenecks. Mechanical advancers position components, while rotatable condiment hoppers provide precise portioning, including squeezable cheese. The AI controller synchronizes operations via orders and sensors. Completed burgers are wrapped or boxed and delivered via chute, minimizing labor needs.

### CROSS REFERENCE TO RELATED APPLICATION

This application is a continuation-in-part of U.S. patent application Ser. No. 18/149,118, entitled “Automated Food Patty Cooking Apparatus,” filed on Jan. 2, 2023, which claims the benefit of the priority of U.S. Provisional Patent Application No. 63/384,388, entitled “Automated Food Patty Cooking Apparatus,” filed on Nov. 18, 2022. The above-identified applications are incorporated herein by reference in their entirety. This continuation-in-part expands upon the embodiment briefly disclosed in paragraph of U.S. patent application Ser. No. 18/149,118, which described depositing a cooked patty onto a conveyor belt with dispensers for buns and condiments followed by an automatic food wrapper, by replacing the conveyor belt with a more detailed, linear assembly and wrapping module using gravity-assisted sliding via chute. The original embodiment focuses on the stand-alone rotary griddle with dispensing tower, which may be preferred for smaller-volume restaurants seeking simple automation without assembly integration.

### BACKGROUND

### Field of Invention

The present invention generally relates to a cooking apparatus, and more particularly, to an automatic food patty cooking, flipping, and assembly apparatus that uniformly cooks the patty and assembles it into a complete food item, such as a hamburger or sandwich.

### Description of Related Art

Hamburgers and similar sandwiches are popular home-cooked meals in many regions. Griddling is commonly used to prepare meat for use in hamburger preparation. Patties are typically fried on conventional griddles to ensure proper protein cooking and flavor development within the cooked meat. The flavors and textures created during the cooking process provide the consumer with a very palatable and desirable experience.

Traditional cooking methods, such as stovetop, ovens, steaming, and so on, take a long time to prepare. U.S. Pat. No. 11,798,343B2 discloses an automatic food preparation line for automatically preparing bread products for making sandwiches or burgers comprises an automatic bread product handling system containing a plurality of different types of bread products, an automatic toaster appliance for toasting the bread products, an automatic packaging system for automatically dispensing both box and wrapping paper packaging. Further, US20190320846A1 discloses a cooking apparatus having a conveyor system having a continuous cooking surface and a dispenser disposed proximate to the continuous cooking surface. The apparatus cooks two sides at the same time.

Prior art automated food assembly systems, particularly for hamburgers, often incorporate cheese dispensers that rely on grated or shredded cheese stored in tubes or hoppers. For example, US20090200408A1 describes an automated cheese shredder that grates cheese from blocks and dispenses shredded cheese onto food items, using mechanisms like pressure plates and rotating graters to apply grated cheese. Similarly, EP3589169B1 discloses hopper-based dispensers for shredded ingredients, including cheese, with paddles and anti-sticking features to handle clumping. However, these grated cheese systems suffer from significant drawbacks: the grated cheese tends to clump together due to moisture or compression in the tube, leading to inconsistent dispensing and uneven distribution on the patty. Clumped cheese can roll off the patty during assembly or cooking, creating messes on assembly surfaces, which poses food safety risks from cross-contamination or unclean conditions.

Moreover, in such prior art systems, the patty may not retain sufficient heat to fully melt the grated cheese, resulting in suboptimal texture, flavor integration, and consumer dissatisfaction. Traditional manual methods require an employee to unwrap a slice of processed cheese or separate a slice from a block and place it on the patty toward the end of grilling, which is labor-intensive and incompatible with fully automated systems. These limitations hinder the efficiency, quality control, and scalability of automated hamburger assembly, particularly in high-volume quick service restaurant (QSR) environments where consistent melt and portioning are critical.

Prior art bun handling systems, such as those in U.S. Pat. No. 11,089,905B2, often rely on single or low-capacity feeders that require frequent manual refills, creating bottlenecks in high-volume operations (e.g., 180 burgers per hour). These systems may use conveyor belts for bun movement, which are difficult to clean and pose food safety risks due to grease accumulation and hard-to-reach areas. Manual loading interrupts workflow, increasing labor costs and limiting throughput.

Prior art manual griddles typically require multiple employees for operation, exacerbating labor shortages and increasing costs. The parent application disclosed an original embodiment focused on the automated cooking apparatus as a stand-alone unit, comprising the rotary griddle with dividers and dispensing tower for uniform patty cooking. This configuration may be preferred for smaller-volume restaurants, providing labor savings and consistent results without integrated assembly.

The present continuation-in-part replaces the conveyor belt assembly briefly mentioned in paragraph [0063] of the parent with an expanded, linear assembly and wrapping module. This module integrates directly with the cooking apparatus via a gravity-assisted chute slide, where the flipper directs patties to the opposite side for linear flow into the module, addressing high-volume needs in QSRs while enhancing hygiene through the use of removable, washable components and mechanical advancing means.

The present invention is meant to be a replacement for manually operated griddles and grills. The most significant advantage is the labor savings over a manual rectangular griddle, which requires an employee to read orders, place the correct patties on the griddle, observe and flip them as needed, and then remove them from the griddle. Many media reports confirm that there is a shortage of 750,000 restaurant workers in the United States, and the minimum wage has been raised to $15 per hour in many states. This may lead to either an increase in prices of restaurant products or closure of restaurants due to lack of staff.

The current invention is also meant to be an alternative to much more expensive and complex robotic devices that cost tens of thousands of dollars or more and use robotic arms and numerous sensors to mimic humans. These complex devices may not survive in a greasy cooking environment without constant repairs. Simple stainless-steel appliances that are easy to maintain are more realistic and cost-effective.

Accordingly, a need exists for an automated food patty cooking apparatus that addresses these needs by one or more aspects of the present invention.

### SUMMARY

The following is a summary description of illustrative embodiments of the invention. It is provided as a preface to assist those skilled in the art to more rapidly assimilate the detailed design discussion which ensues and is not intended in any way to limit the scope of the invention which are appended hereto in order to particularly point out the invention.

According to illustrative embodiments, the present disclosure focuses on an automated food patty cooking and assembly apparatus which partially overcomes the above-mentioned disadvantages or provides the users with a useful or commercial choice. It is a principal object of the present invention to provide an apparatus that successfully overcomes the deficiencies of the prior art.

In a preferred embodiment, the apparatus comprises the standalone rotational griddle as disclosed in the parent U.S. patent application Ser. No. 18/149,118, which provides efficient automated cooking without the integrated assembly and wrapping module.

According to an embodiment of the present invention an automated food patty cooking and assembly apparatus is disclosed. In the original stand-alone embodiment from the parent application, suitable for smaller-volume restaurants, the apparatus includes a switch on and switch off button on the apparatus's housing. The apparatus includes at least four supporting elements for providing support to the housing when it is placed on the ground. The apparatus comprises a horizontal rotating griddle mounted on the housing. The apparatus comprises a horizontal rotating griddle with dividers that can be heated to automatically griddle hamburger/sandwich patties. The apparatus also includes a dispensing component that is attached to the horizontal rotating griddle and loaded with patties made from various meats, cheeseburgers, or vegan patties. The dispensing component dispenses frozen patties onto the griddle between the dividers of the horizontal rotating griddle for frying. The dispensing component is designed to hold a number of uncooked hamburger patties. The patty dispenser in a preferred embodiment of the present invention comprises horizontal trays stacked on top of one another in a tower tray holder. The apparatus also has tower tray holders for moving patties up and down. Each horizontal tray holds one patty that can move vertically up and down and dispense any type of patty.

In this stand-alone embodiment, cooked patties are delivered via the chute slide to a storage bin or manual assembly area, without integrated automation beyond cooking.

Embodiments in accordance with the present invention provide that patties are placed one by one on the horizontal rotating griddle as it rotates in a circular motion. The rotation of the horizontal rotating griddle in one embodiment of the present invention may be timed so that one rotation is long enough to cook the patty on one side. Furthermore, after the patties have been rotated and cooked on a first side via a first cooking stage comprising approximately 1.5 rotations (e.g., about 2 minutes at a first rotational speed), each patty is flipped over one by one using a flipper positioned on an opposite side of the griddle from the dispensing station, the flipper capable of moving in either direction via an adjustable component. In an embodiment of the present invention, the adjustable component may be associated with a chute slide and flipper. In an embodiment of the present invention, the flipper may be preset to flip the patties automatically at a preset time to the adjacent divider of the horizontal rotating griddle.

In an embodiment of the present invention, the dividers may be removable divider components. Each divider component may comprise a heating element that is controlled via the AI controlled module. The AI control module adjusts the rotational speed variably between the first and second cooking stages to maintain consistent cooking times (e.g., accelerating rotation during the shorter second stage of approximately 1.0 rotation for about 2 minutes), optimizing for patty type, thickness, and demand.

In an embodiment of the present invention, disclosed in the parent application, after the patties have finished cooking, the flipper lifts them off the griddle and tilts them up, using gravitational forces to slide them down a chute onto the conveyor belt or, alternatively, into a storage bin for further use. In the embodiment, the flipper may automatically lift the patties and slide them down a chute slide when the patties are cooked properly. In an embodiment there may be a sensor as to when the flipper may move the patties to the chute slide.

In one embodiment of the present invention, the apparatus may include a touch screen with a user-friendly graphical user interface for controlling the apparatus. When a customer places an order, the user interface receives data from online orders and immediately dispenses patties onto the horizontal rotating griddle. In the embodiment, the apparatus may also use artificial intelligence based on historical data and other factors to predict high volume times in order to increase delivery speed by cooking patties ahead of high-volume orders being placed.

According to an embodiment of the present invention, the present invention discloses an apparatus that uses non-meat, frozen, or thawed patties. To deal with fluctuating demand and supply, the device employs artificial intelligence based on historical data and other factors. The apparatus is designed to automatically griddle hamburger/sandwich patties using a heated rotating griddle with a timed rotational cycle.

The apparatus may include infrared sensors to detect the final temperature of the patties to ensure they are thoroughly cooked. The temperature sensor can be linked to the AI system to optimize rotational speed and heating element temperature.

Embodiments in accordance with the present invention provide a process for automatically cooking a plurality of patties. The process includes receiving an order placed by a customer on a user interface. The process also includes pushing a switch on button positioned on the outer surface of the apparatus. The process also includes dispensing patties onto a horizontal rotating griddle between dividers of a horizontal rotating griddle for frying via a dispensing component. The process also includes stacking a plurality of horizontal trays on top of one another in a tower tray holder. The process also includes moving the patties either up or down depending on which type of patty is requested in the tower tray holders by using an AI control module. The process also includes pushing each patty from horizontal tray onto the horizontal rotating griddle via an actuated push component. The process also includes detecting temperature of the patties using temperature sensors which are linked to the artificial intelligence (AI) control module to optimize rotational speed and a heating element's temperature. The process also includes flipping each patty using a flipper attached to a chute slide and associated with the horizontal rotating griddle that is capable of moving either direction. The process also includes delivering the patty to a conveyor belt via the chute slide, and then into a storage bin.

In one embodiment of the present invention, the process further comprises monitoring historical data and a plurality of factors using the artificial intelligence (AI) control module to predict high volume times in order to increase delivery speed by cooking patties ahead of high-volume orders being placed.

Additional embodiments of the present invention provide an assembly module integrated with the cooking apparatus for automatically assembling cooked patties into complete food items, such as hamburgers. This expanded embodiment replaces the parent's conveyor belt by configuring the flipper to direct patties to the opposite side of the griddle for linear flow, allowing gravity to slide the patty down the chute directly into the assembly module. The module receives the cooked patty from the chute slide and positions it on a bottom bun half dispensed from a bottom bun tube located beneath the assembly line. The bottom bun tube pushes the bottom bun half upward to an initial assembly station, where a mechanical lift/transfer mechanism places the patty onto the bun. The patty and bottom bun are then advanced to the condiment station by mechanical advancing means. A new bottom bun half then automatically pops up in the initial assembly station. At the condiment station, a plurality of hoppers dispenses condiments such as squeezable cheese (which may be heated via a heating element in the hopper if necessary), shredded salad, ketchup, mustard, and relish. The cheese hopper is distinguished from prior art grated cheese dispensers by utilizing squeezable cheese or a processed cheese product that is forced out with a plunger or screw system for accurate and even distribution, ensuring exact portion control, quality, and amount without clumping or rolling off the patty. This addresses food safety concerns and melting issues in automated systems. The hoppers and tubes are removable and washable by hand or in a dishwasher for maintenance and compliance with food safety standards. The assembly is then advanced by mechanical means to a wrapping station, where it is wrapped, labeled, and pushed via mechanical means down a delivery chute for output. The wrapper is more economical than a box, uses less space which means fewer refills are required (less labor), and minimizes waste and environmental footprint; but in an alternative embodiment it could package the completed burger in a card box.

In embodiments, the mechanical advancing means comprises an actuated arm or rod that extends and retracts to move the assembly without a continuous conveyor belt. The artificial intelligence (AI) control module coordinates the timing of the mechanical advancing means, hopper dispensing, and wrapping based on customer orders, historical data, and factors such as predicted high-volume periods. The cheese hopper solves the automation challenge of cheese addition, where prior systems rely on grated cheese in tubes that can clump, create messes, or fail to melt properly due to insufficient patty heat. By heating the dispenser container to a precise temperature, the squeezable cheese dispenses easily without cooling the hamburger, enhancing melt adhesion and flavor.

The assembly module may also include a top bun tube for dispensing the top bun half onto the assembly at an appropriate station, such as after condiment dispensing. Most QSR restaurants use processed cheese, which can be purchased in a viscous state that tastes similar to traditional slices, satisfying consumer demand while enabling competitive pricing and efficient automation. To address bun loading bottlenecks in prior art systems, the bottom and top bun tubes comprise multiple parallel tubes arranged in a rotary carousel for high-capacity storage and dispensing, enabling operation at rates of up to 180 burgers per hour or more with minimal refills. The carousel system eliminates the need for conveyor belts, which are hard to clean and pose food safety risks, by rotating empty tubes out of position and full tubes into alignment via a motor-driven vertical shaft, controlled by the AI module.

The stand-alone embodiment may be preferred for smaller restaurants, while this expanded linear module is optimized for high-volume QSR environments with gravity-assisted integration.

The present invention ensures that the food patty is cooked to a high standard and uniformly without overcooking the patty. The automation provided by the apparatus may significantly reduce labor requirements, potentially enabling a single employee to oversee operations in a takeout restaurant setting.

These and other advantages will be apparent from the present application of the embodiments described herein.

The preceding is a simplified summary to provide an understanding of some embodiments of the present invention. This summary is neither an extensive nor exhaustive overview of the present invention and its various embodiments. The summary presents selected concepts of the embodiments of the present invention in a simplified form as an introduction to the more detailed description presented below. As will be appreciated, other embodiments of the present invention are possible utilizing, alone or in combination, one or more of the features set forth above or described in detail below.

### BRIEF DESCRIPTION OF THE DRAWINGS

The above and still further features and advantages of embodiments of the present invention will become apparent upon consideration of the following detailed description of embodiments thereof, especially when taken in conjunction with the accompanying drawings, and wherein:

FIG. 1A illustrates a perspective view of an automated food patty cooking apparatus, according to embodiments of the present invention wherein the flipper is positioned on the same side as the dispensing tower without an integrated assembly and wrapping module;

FIG. 1B illustrates a side view of an automated food patty cooking apparatus, according to embodiments of the present invention disclosed herein;

FIG. 1C illustrates a perspective view of an automated food patty cooking apparatus dispensing patties, according to embodiments of the present invention disclosed herein;

FIG. 1D illustrates a perspective view of an automated food patty cooking apparatus dispensing patties in timed rotational cycle, according to embodiments of the present invention disclosed herein;

FIG. 1E illustrates a perspective view of an automated food patty cooking apparatus flipping over a patty after completion of cooking on one side, according to embodiments of the present invention disclosed herein wherein the flipper is positioned on the same side as the dispensing tower;

FIG. 1F illustrates another perspective view of an automated food patty cooking apparatus flipping over a patty, according to embodiments of the present invention disclosed herein wherein the flipper is positioned on the same side as the dispensing tower;

FIG. 1G illustrates a perspective view of an automated food patty cooking apparatus lifting off a patty by the flipper according to embodiments of the present invention disclosed herein; and

FIG. 1H illustrates a perspective view of an automated food patty cooking apparatus moves a patty down the chute slide according to embodiments of the present invention disclosed herein; and

FIG. 1I illustrates a perspective view of an automated food patty cooking apparatus moving the patty from the chute slide to a conveyor or storage according to embodiments of the present invention disclosed herein wherein the flipper is positioned on the same side as the dispensing tower without an integrated assembly and wrapping module.

FIG. 2 illustrates a perspective view of dividers of the automated food patty cooking system, according to embodiments of the present invention disclosed herein.

FIG. 3A illustrates a block diagram of an automated food patty cooking system, according to embodiments of the present invention disclosed herein.

FIG. 3B illustrates an updated block diagram extending FIG. 3A, illustrating the flow from patty receipt, bun dispensing, advancing via actuated arm, condiment dispensing via rotating carousel, top bun placement, wrapping (wrapper primary, box alternative), and delivery.

FIG. 4A illustrates a process for automatically cooking a plurality of patties, according to embodiments of the present invention disclosed herein.

FIG. 4B illustrates an updated flow diagram of the automatic hamburger assembly process extending FIG. 4A, including continuous loop rotation for bun dispensing, rotating condiments dispenser, and wrapping station according to embodiments of the present invention disclosed herein.

FIG. 5 illustrates a perspective view of the entire hamburger/sandwich production line showing integration of the temperature-controlled patty dispensing tower 122, automated patty cooking apparatus 100, and assembly and wrapping module 200 with the flipper relocated to the opposite side of the griddle, enabling asymmetric cooking arcs (1.5 rotations pre-flip, 1.0 post-flip), according to another embodiment of the present invention.

FIG. 6A illustrates a top plan view of the assembly and wrapping module in accordance with an embodiment of the present invention. The module includes a lift/transfer mechanism 210 configured to elevate and transfer a cooked patty onto a bottom bun dispensed adjacently from a lower dispenser 220. Adjacent thereto is a condiment station featuring a rotating carousel 230, mounted on a vertical shaft and positioned over the assembly line for sequential dispensing of condiments. At the subsequent station, a top bun is dispensed from above through tubular hoppers 240 secured to an overhead-mounted continuous loop conveyor (e.g., chain-driven). Following this is the wrapping station 250 for enclosing the assembled product, and finally, sloped delivery chutes 260 for outputting the wrapped items.

FIG. 6B illustrates a cross-sectional side view of the assembly and wrapping module 200 with bottom bun tubes mounted onto a continuous loop pushing bun upward 220, top bun tubes mounted overhead on a continuous loop 240, and a vertical shaft mounted rotating condiment carousel 230 positioned forward of the top bun loop and aligned with the assembly line for accurate dispensing.

### DETAILED DESCRIPTION

The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include”, “including”, and “includes” mean including but are not limited to. To facilitate understanding, like reference numerals have been used, where possible, to designate like elements common to the figures. Optional portions of the figures may be illustrated using dashed or dotted lines, unless the context of usage indicates otherwise.

The following description includes the preferred best mode of one embodiment of the present invention. It will be clear from this description of the invention that the invention is not limited to these illustrated embodiments, but the invention also includes a variety of modifications and embodiments thereto. Therefore, the present description should be seen as illustrative and not limiting. While the invention is susceptible to various modifications and alternative constructions, it should be understood that there is no intention to limit the invention to the specific form disclosed, but, on the contrary, the invention is to cover all modifications, alternative constructions, and equivalents falling within the scope of the invention.

In any embodiment described herein, the open-ended terms “comprising,” “comprises,” and the like (which are synonymous with “including,” “having” and “characterized by”) may be replaced by the respective partially closed phrases “consisting essentially of,” “consists essentially of,” and the like or the respective closed phrases “consisting of,” “consists of”, or the like.

As used herein, the singular forms “a”, “an”, and “the” designate both the singular and the plural, unless expressly stated to designate the singular only.

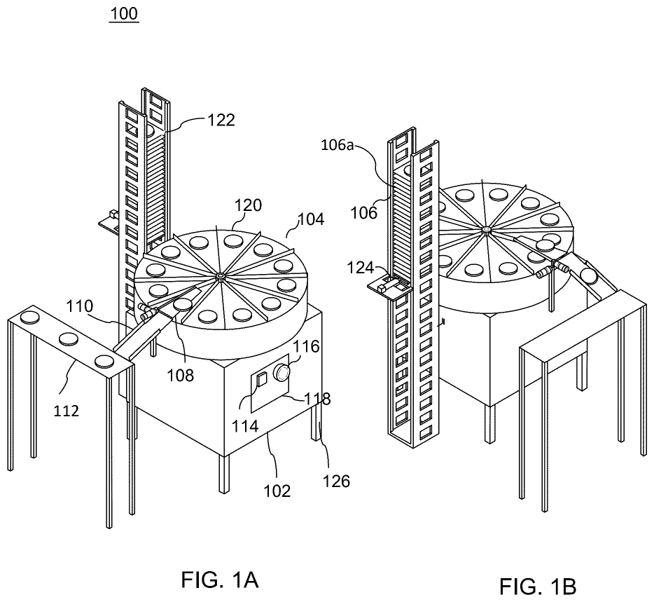

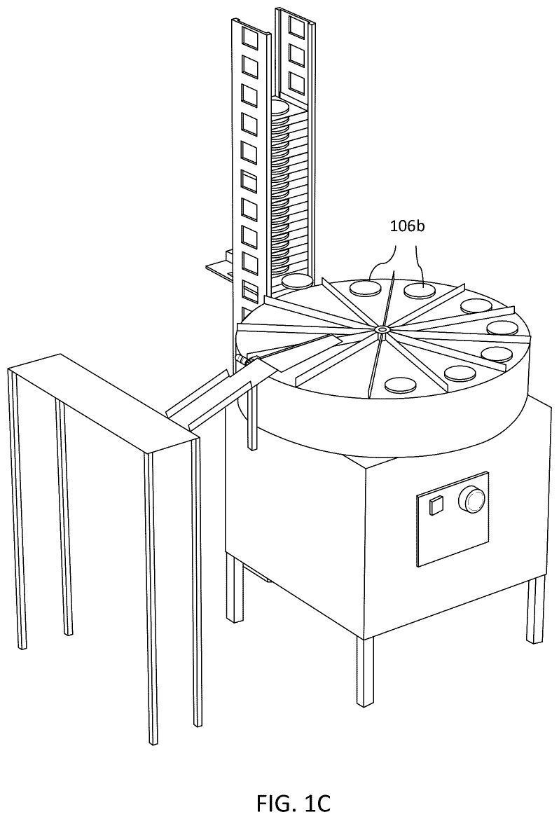

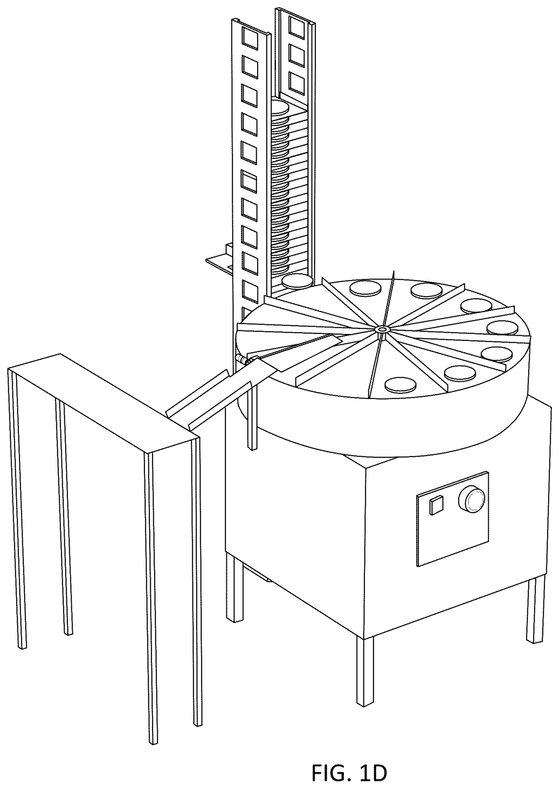

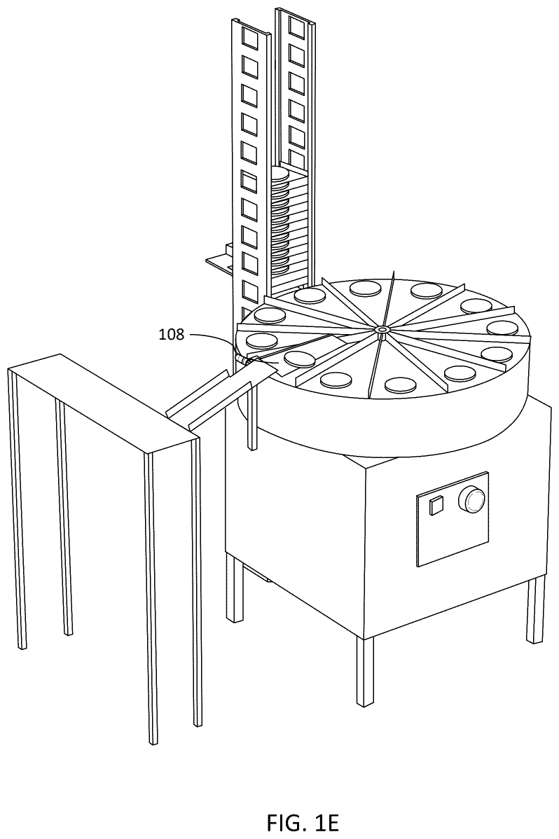

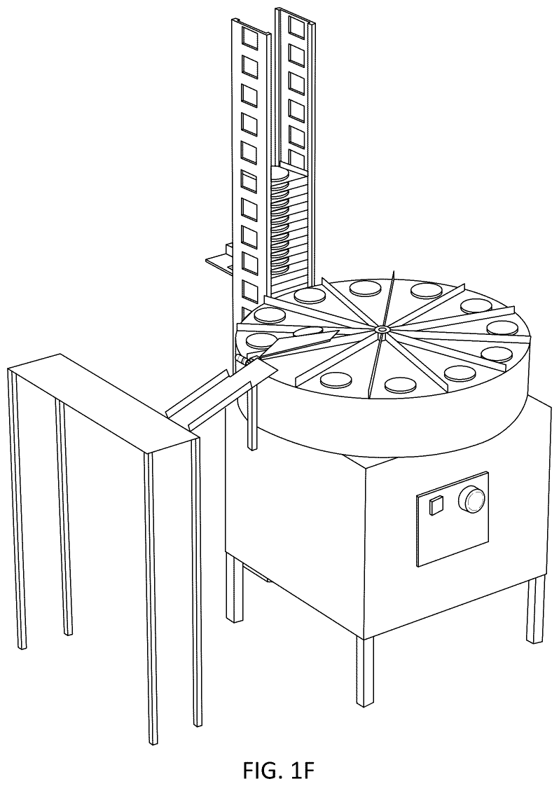

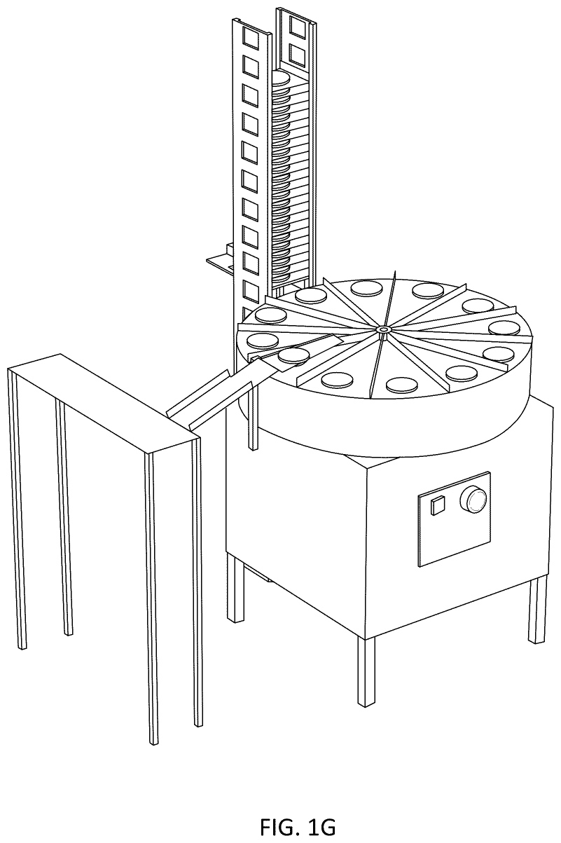

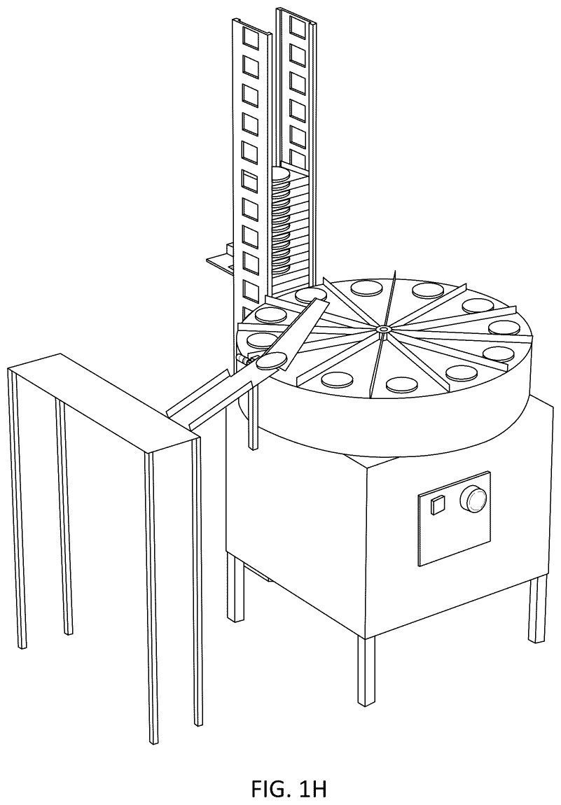

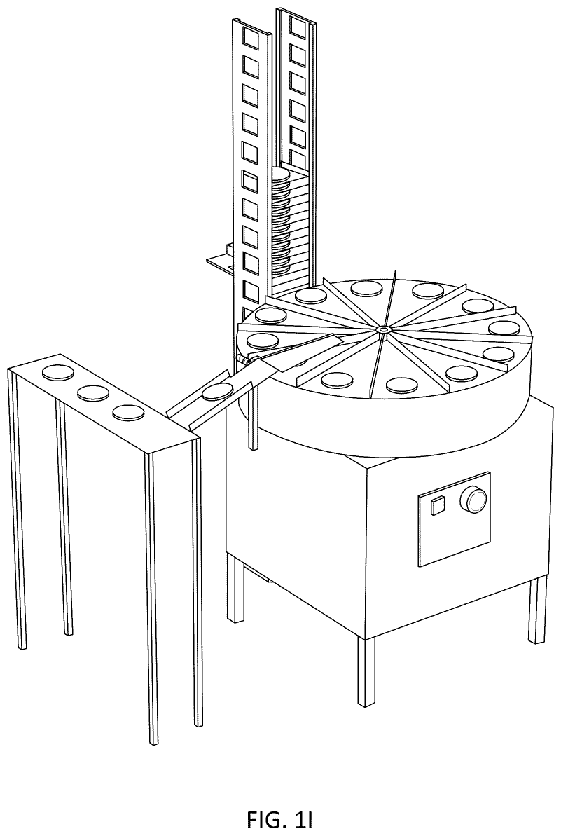

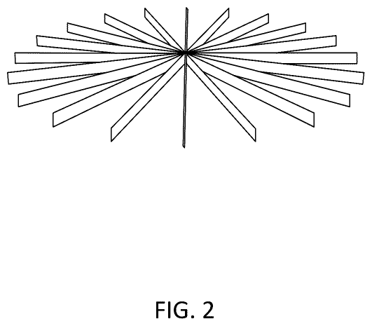

FIG. 1A to FIG. 1I illustrate various views of the automated food patty cooking apparatus 100, according to embodiments of the present invention disclosed in the parent application, in a stand-alone configuration without the assembly and wrapping module. In specific reference to FIG. 1A to FIG. 1B, the automated food patty cooking apparatus 100 comprises a housing 102, a horizontal rotating griddle 104, a dispensing component 106, a flipper 108, a chute slide 110, a conveyor 112, and so forth.

The apparatus 100 in one embodiment of the present invention includes a switch on button 114 and switch off button 116 located on the apparatus's housing 102. The apparatus 100 includes at least four supporting elements 126 for providing support to the housing 102 when it is placed on the ground. The housing 102 may further comprise a touch screen 118 or tablet that may be used to control the apparatus 100 via a user-friendly graphical user interface.

The user interface receives data from online orders and immediately dispenses patties onto the horizontal rotating griddle 104 after a customer places an order. The switch off button 116 may be red color and switch on button 114 may be present within the user interface as green color.

The apparatus 100 may comprise the horizontal rotating griddle 104 mounted on the housing 102. The apparatus 102 may comprise the horizontal rotating griddle 104 with a plurality of dividers 120 that may be heated to automatically griddle hamburger/sandwich patties.

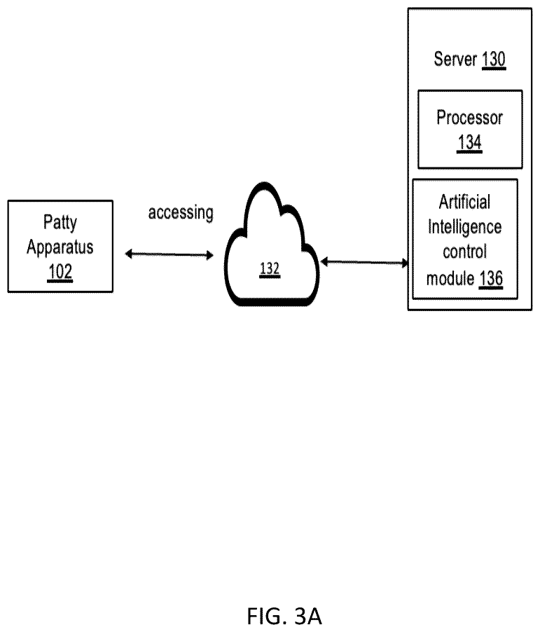

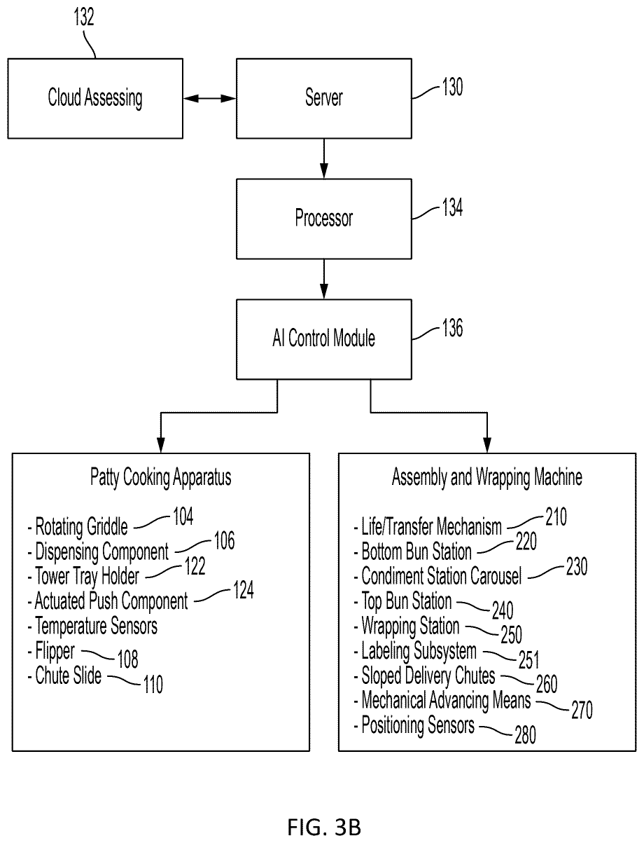

In an embodiment the griddle 104 may be at same temperature throughout. In another embodiment, the griddle may have a plurality of cooking stations. Each of the plurality of cooking stations has its own heating element that is individually controlled by the AI control module 136 (as shown in FIG. 3). Furthermore, the plurality of dividers 120 can be used to assist in keeping chicken, beef and vegan patties from cross contamination by dedicating various stations for one type of patty. The griddle includes up to 12 separated cooking surfaces defined by the dividers, enabling batch cooking of up to 12 patties simultaneously during peak times, with smaller batches (e.g., 1-6 patties) during off-peak periods to conserve energy and reduce waste, as determined by the AI control module based on actual or predicted demand. The AI control module 136 remembers which frying stations belong to which patty or type of food group if desired, and controls the temperature and rotational speed, and number of rotations required for each type of patty depending on size and composition.

In an embodiment of the present invention, the dispensing component 106 may be attached to the horizontal rotating griddle 104 and loaded with patties made from various meats, cheeseburgers, or vegan patties. The dispensing component 106 may dispense patties onto the dividers 120 of the horizontal rotating griddle 104 for cooking, as seen in FIG. 1C. The dividers 120 may be removable divider components, each divider component comprises a heating element that is controlled via AI controlled module 136. The dividers 120 may be attached to a rotating axel at center, each divider component has a small protrusion at the end of the divider 120 which fits into a corresponding notch in a griddle surface of the griddle 104.

In reference to the FIG. 1C-FIG. 1D, a plurality of patties 106b is dispensed on the horizontal rotating griddle 104 by the dispensing component 106. The horizontal trays 106a are arranged vertically with a plurality of patties 106b in the plurality of horizontal trays 106a. In the embodiment the dispensing component 106 is equipped to dispense the patties from the lower end onto the horizontal rotating griddle 104. In the embodiment the movement of the trays in the dispensing device is towards the horizontal rotating griddle 104.

The dispensing component 106 is intended to hold a number of uncooked hamburger patties in a tower tray-holder 122 for moving patties either up or down depending on which type of patty is desired. In one of the embodiments of the present invention, the dispensing component 106 may comprise an actuated push component 124 for pushing the patty from horizontal tray 106a onto the horizontal rotating griddle 104.

In a preferred embodiment, horizontal trays 106a of the dispensing component 106 are stacked on top of one another in the tower tray holder 122. Each horizontal tray 106a holds one patty that can move vertically up and down and dispense any type of patty.

According to embodiments of the present invention, the tower tray holder 122 can be heated to thaw frozen patties prior to being dispensed onto the horizontal rotating griddle 104. Each of the horizontal trays 106a present in the tower tray holder 122 can have a heating element to accelerate thawing.

In an alternative embodiment of the present invention, the tower tray holder 122 can be enclosed with a door on the back for access and insulated for refrigeration of the patties while they are being held in order to comply with various food safety regulations depending on the jurisdiction. Each divided space on the heating surface can have an individual heating element. The AI control module 136 can be adapted to optimize cooking for each patty individually depending on the type of patty optimizing the rotational speed of the griddle, the temperature of the patty dispensing tower, the temperature of each heating element, and the flipping action.

After each patty is cooked, a scrubbing arm (or other device) can be used to quickly clean the area and prepare it for the next patty. The apparatus 100 may comprise infrared sensors to detect the final temperature of the patties to ensure they are thoroughly cooked. The temperature sensor can be integrated with the AI system to optimize rotational speed and the temperature of the heating elements. The AI system implements variable rotational speeds between cooking stages to account for the flipper's position on the opposite side, ensuring the first stage covers approximately 1.5 rotations in about 2 minutes and the second stage covers approximately 1.0 rotation in about 2 minutes, with speed adjustments (e.g., slower initial speed for searing, faster post-flip for finishing).

The patties are placed one by one on the horizontal rotating griddle 104 as it moves in a circular motion, as seen in FIG. 1D. In one embodiment of the present invention, the rotation of the horizontal rotating griddle 104 may be timed so that one rotation is long enough to cook a typical commercial hamburger patty on one side prior to being flipped. The cooking process would then be complete at the end of the second rotation when the flipper 108 moves the patty to the chute slide 110, and onto a conveyor belt 112 or, alternatively, into a storage bin, as seen in FIG. 1G, FIG. 1H and FIG. 1I. Thereafter, an actuated cleaning arm prepares the griddle for the next patty. This variable speed enables modular reconfiguration of the apparatus as a linear production line (e.g., by replacing the circular griddle with an equivalent linear conveyor having 12 sequential cooking stations), maintaining throughput of up to 180 patties per hour by adjusting conveyor speed analogously to the rotational speed variations.

In an embodiment of the present invention, the system 100 comprises circular shaped trays all the way around the rotating griddle to catch drippings, in addition to the actuated scrubber and a small tray for the scrubber/scraper. The trays that extend all the way around the cooking surface are divided into four, each of which is a quarter circle, and about 3-4″ wide and rest on metal brackets which hold them in place. In an embodiment of the present invention, a stainless-steel splash guard may be present on the back of the apparatus. This can be a riser which is 6-10″ high to protect the wall and make cleaning easier.

For the patty tower cleaning, each patty can be on its own reusable tray which then goes into a dishwasher, or each shelf can have its own reusable removable tray which goes into the dishwasher for cleaning at the end of the day. Trays can be color coded to correspond to different food groups. The system 100 may further comprise splash guards and grease trays.

In an embodiment, the griddle 104 can cook one side of the patty in one rotation and then flip the patty to cook on the other side. A commercial burger patty can range from approximately two ounces for a regular size fast food patty to four ounces for a premium sized patty. In the embodiment, the AI control module 136 configured to know which type of patty is dispensed on which location on the horizontal griddle 104. In the embodiment, the thicker patty could go around twice to be cooked on one side and then flipped while the regular size only needs one rotation per side. In another embodiment, the number of the rotations of the griddle for cooking a patty depends upon its size and thickness before being flipped to the second side for cooking and the AI control module 136 may be configured to determine the number of rotations or time before the patty is flipped to other side for cooking. In one embodiment the whole griddle is set to one temperature. In a preferred embodiment the speed of rotation, flipping and temperature of each individual divided space on the griddle could be adjusted and optimized by the AI system depending on the customer orders. Variable speed rotation between stages further allows for asymmetric cooking arcs due to flipper relocation, with batches limited to 12 patties max to align with the 12 surfaces, enabling efficient linear reconfiguration without throughput loss. In one of the preferred embodiments, a small 2 oz patty goes around twice (one each side) while the 4 oz patty stays on for a longer duration such as four rotations in total (two each side).

Referring to FIG. 1E and FIG. 1F, after the patties have been rotated and cooked on one side, they are flipped over one by one using the flipper 108 that can be moved in either direction via an adjustable component. The dividers 120 assist in pushing the patties onto the flipper. The dividers 120 could also keep different types of patties from cross contaminating each other such as vegetarian and beef. In an embodiment of the present invention, the adjustable component may be associated with the chute slide 110 and the flipper 108. In a preferred embodiment of the present invention, the apparatus 100 is for automatically cooking hamburger/sandwich patties utilizing a heated rotating griddle along with a timed rotational cycle.

In an embodiment of the present invention, the dividers 120 may separate types of food keeping vegan options separate from beef and chicken, each having its own AI controlled heating element. In one of the preferred embodiments of the present invention, the dividers 120 may be removable for cleaning so that the griddle surface can be cleaned with a regular scraper just like a manually operated griddle.

Drippings and scrapings can go into the circular trays around the outside which can then be removed and put into a dishwasher or washed in a sink along with the other trays and the divider 120 component.

The divider 120 may be attached to a rotating axel at the center. At the extremity of each divider 120, they are held in place firmly by having a small protrusion at the end which fits into a corresponding notch in the griddle surface. This way the individual heating spaces are always centered in the middle of each divided space on the griddle and the dividers are held firmly in place. The removable divider element is key to the ease of maintenance because it is supposed to be a time saving system 100. In an embodiment of the present invention, the dividers 120 may be removable in nature to clean up the griddle surface.

According to embodiments of the present invention, the patty may be any meat, non-meat, frozen, thawed, and so forth.

The chute slide 110 may extend from the horizontal rotating griddle 104 into the assembly module, allowing the cooked patty to slide under the force of gravity down the sloped chute to the lift/transfer mechanism 210 for initiation of the assembly process.

The apparatus 100 may also use artificial intelligence based on historical customer data and other factors to take care of fluctuating demand and supply variation. The apparatus 100 may predict high volume periods in order to increase delivery speed by thawing or cooking patties ahead of high-volume orders being placed using artificial intelligence based on historical customer data and other factors. The AI control module 136 can also be integrated into the inventory system of the restaurant and automatically order more ingredients when needed. The AI also manages batch sizes up to 12 patties during peaks and smaller batches off-peak, with variable speeds supporting linear line configurations for flexible kitchen layouts.

FIG. 3A illustrates a block diagram of an automated food patty cooking system, according to embodiments of the present invention. The apparatus 100 may be associated with a server 130 over a network 132. The AI control module 136 may be used to control a plurality of operations of the apparatus 100. The touch screen 118 may be associated with the AI control module 136 to control the apparatus 100 via a user-friendly graphical user interface. A processor 134 may process a plurality of parameters to control the apparatus 100.

FIG. 3B provides an updated block diagram extending FIG. 3A, illustrating the automated food preparation system in accordance with embodiments of the present invention, building upon the parent system's architecture to integrate the assembly and wrapping machine alongside the patty cooking apparatus. The system includes a cloud assessing component 132 bidirectionally connected to a server 130, which interfaces with a processor 134 that in turn communicates with an AI control module 136. The AI control module 136 branches to manage both the patty cooking apparatus-comprising elements such as the horizontal rotating griddle 104, dispensing component 106, tower tray holder 122, actuated push component 124, temperature sensors, flipper 108, and chute slide 110, and the new assembly and wrapping machine, which features the lift/transfer mechanism 210, condiment station carousel 230, top bun tubular hoppers 240, wrapping station 250, labeling subsystem 251, sloped delivery chutes 260, mechanical advancing means 270, and positioning sensors 280. This configuration enables seamless coordination between cooking, assembly, and packaging processes, with the AI control module 136 optimizing operations based on inputs from the processor 134 and cloud data.

The present invention has the same footprint as a standard commercial griddle, allowing the apparatus to be easily swapped in without the need for renovations and the use of more valuable kitchen space. It will be flush with the other kitchen appliances, such as ovens, and will fit beneath the existing hood fan. The cost of replacing a commercial hood fan with built-in fire extinguishers with a new custom-made hood fan is significant. Its utility is increased because it has a much lower initial cost, maintenance cost, and repair cost when compared to more complex robotic arm devices.

In an embodiment of the invention, the apparatus 100 may include an option for mechanical advancing means, such as synchronized push rods or pneumatic actuators 270, that propel the assembled food product through stations featuring dispensers for bottom buns from below and top buns from above via tubular hoppers 220, along with a condiment carousel 230, culminating in an automatic food wrapper at the wrapping station 250 that encloses the food and applies a label via the labeling subsystem 251 with customer order details, including order number or customer name.

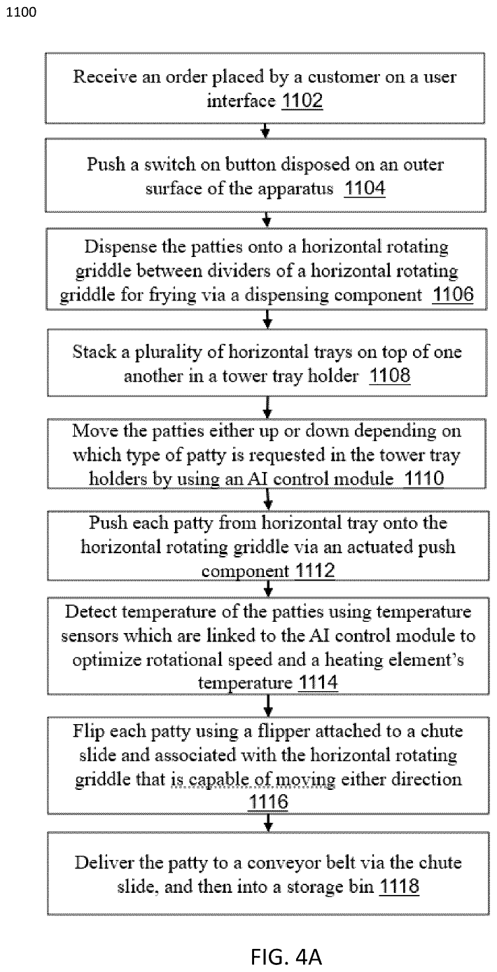

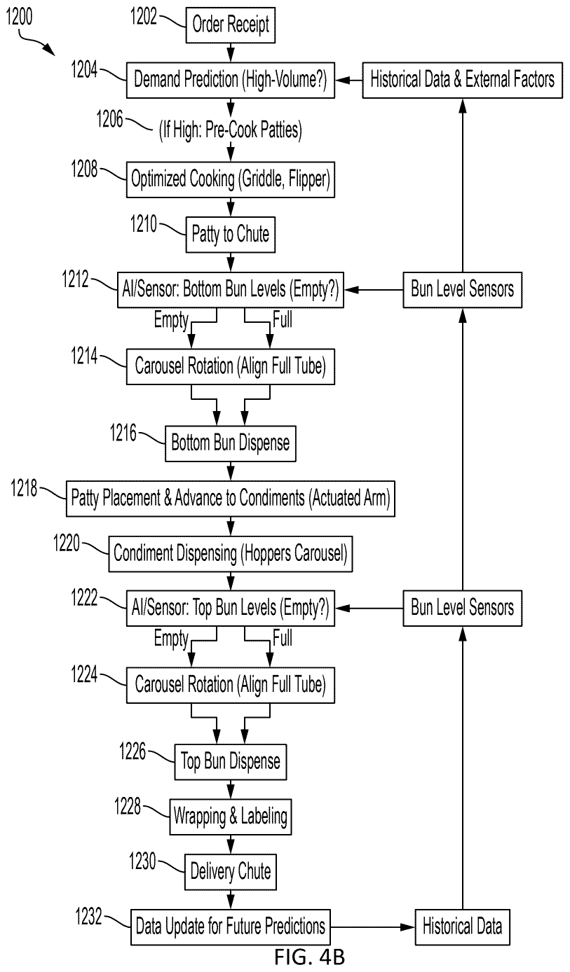

FIG. 4A illustrates a process 1100 for automatically cooking a plurality of patties, according to embodiments of the present invention.

At 1102, receiving an order placed by a customer on the user interface.

At 1104, pushing the switch on button 114 disposed on an outer surface of the apparatus.

At 1106, dispensing the patties onto the horizontal rotating griddle 104 between dividers 120 of the horizontal rotating griddle 104 for frying via the dispensing component 106.

At 1108, stacking the plurality of horizontal trays 106a on top of one another in the tower tray holder 122.

At 1110, moving the patties either up or down depending on which type of patty is requested in the tower tray holders 122 by using an AI control module 136.

At 1112, pushing each patty from horizontal tray 122 onto the horizontal rotating griddle 104 via the actuated push component 124.

At 1114, detecting temperature of the patties using temperature sensors which are linked to the artificial intelligence (AI) control module 136 to optimize rotational speed and a heating element's temperature.

At 1116, flipping each patty using the flipper 108 attached to the chute slide 110 and associated with the horizontal rotating griddle 104 that is capable of moving either direction.

At 1118, delivering the patty via the chute slide 110 into the assembly module, where it slides under gravity to the lift/transfer mechanism 210 for elevation and transfer onto the bottom bun, commencing the assembly and wrapping sequence.

In an embodiment of the present invention, the process further comprises monitoring historical data and a plurality of factors using the artificial intelligence (AI) control module 136 to predict high volume times in order to increase delivery speed by cooking patties ahead of high-volume orders being placed.

In embodiments, the AI control module 136 implements algorithms to optimize the apparatus's operations. The following pseudo code illustrates an example implementation for predicting demand, controlling griddle rotations, and coordinating assembly:

```
Pseudo Code for AI Control Module
Import necessary modules (for illustration; actual implementation may vary)
import historical_data # Database of past orders, times, and factors
import sensors # Temperature, order input, etc.
import actuators # For griddle speed, flipper, pusher, hoppers
Function 1: Predict high-volume periods and pre-cook patties
def predict_demand(current_time, factors): # factors: weather, day of week,
events, etc.
  high_volume = False
  predicted_orders = analyze_historical_data(historical_data, current_time,
  factors) # Use ML model (e.g., regression)
  if predicted_orders > threshold: # e.g., 50% above average
    high_volume = True
    pre_dispense_patties(predicted_orders) # Dispense and start cooking
    ahead
  return high_volume
Function 2: Optimize griddle cooking for a patty
def optimize_cooking(patty_type, current_temp): # patty_type: beef, vegan,
etc.
  target_temp = get_optimal_temp(patty_type) # From lookup table or ML
  rotations_needed = calculate_rotations(patty_type.size,
  patty_type.thickness) # e.g., 2 for small, 4 for large
  stage1_rotations = 1.5; stage2_rotations = 1.0;batch_size = min(12,
  predicted_demand); # Limit to 12 surfaces, smaller for off-peak
  while cooking_in_progress:
    sensor_temp = sensors.read_temperature( )
    if sensor_temp < target_temp:
    actuators.increase_heating( )
    actuators.set_rotation_speed(rotations_needed / cooking_time)# Adjust
    speed
    if stage == ‘first’: actuators.set_rotation_speed(stage1_rotations /
    2); # ~2 minelif stage == ‘second’:
    actuators.set_rotation_speed(stage2_rotations / 2); # ~2 min,
    variable if rotations_completed >= rotations_needed:
    actuators.activate_flipper( )# Flip or send to chute
    break
    return “Patty cooked”
Function 3: Coordinate assembly process
def assemble_burger(order_details): # order_details: condiments, bun type,
etc.
  actuators.push_bottom_bun( ) # From tube below
  actuators.place_patty_on_bun( ) # Using mechanical pusher
  actuators.push_to_condiment_station( ) # Move assembly
  for condiment in order_details.condiments: # e.g., [“ketchup”, “mustard”,
  “relish”, “squeezable_cheese”]
    if condiment == “squeezable_cheese”:
    actuators.heat_hopper(cheese_hopper) # If necessary for viscosity
    actuators.dispense_from_hopper(condiment) # Dispenses all condiments
    via plunger/screw; no heat for non-cheese
  actuators.dispense_top_bun( ) # From tube above
  actuators.push_to_wrapping_station( )
  actuators.wrap_and_label(order_number)
  actuators.push_to_delivery_chute( )
  return “Burger assembled and delivered”
Main Loop: Integrate with user interface and sensors
while apparatus_on:
  order = user_interface.receive_order( )
  if predict_demand(current_time, external_factors):
  pre_cook_patties( )
  cooked_patty = optimize_cooking(order.patty_type, sensors.temp)
  assembled_burger = assemble_burger(order)
  update_historical_data(order, performance_metrics) # For future
  predictions
```

This pseudo code is illustrative and can be implemented in various programming languages. The AI control module may use machine learning models (e.g., trained on historical data) to refine predictions and optimizations over time.

FIG. 4B provides a process flow diagram extending FIG. 4A illustrating the flow of operations in the AI control module 136, as referenced in the pseudo code of [0092]. The diagram shows the sequence from order receipt through demand prediction, pre-cooking (if high volume), optimized cooking, burger assembly, and data update for future predictions. Arrows indicate data flow and control signals between modules.

FIG. 4B illustrates a process 1200 for automatically assembling and wrapping burgers based on order receipt and demand prediction, according to embodiments of the present invention, extending the cooking process of FIG. 4A.

At 1202, receiving an order placed by a customer, initiating the assembly sequence.

At 1204, performing demand prediction to assess if high-volume production is required, utilizing historical data and external factors for optimization.

At 1206, if high-volume is predicted, pre-cooking patties in advance to meet anticipated demand.

At 1208, conducting optimized cooking on the griddle with flipper mechanisms to prepare patties efficiently.

At 1210, transferring the cooked patty to the chute for entry into the assembly module.

At 1212, monitoring bottom bun levels using AI and sensors to detect if tubes are empty, with input from bun level sensors.

At 1214, if levels indicate empty or full, rotate the carousel to align a full tube for dispensing.

At 1216, dispensing the bottom bun from the aligned tube onto the assembly path.

At 1218, placing the patty onto the bottom bun and advancing the assembly to the condiments station using an actuated arm or similar mechanical means.

At 1220, dispensing condiments onto the patty via the hopper carousel positioned over the assembly line.

At 1222, monitoring top bun levels using AI and sensors to detect if tubes are empty, with input from bun level sensors.

At 1224, if levels indicate empty or full, rotate the carousel to align a full tube for dispensing.

At 1226, dispensing the top bun from the aligned tube onto the assembled burger.

At 1228, performing wrapping and labeling of the completed burger, including application of custom labels based on order details.

At 1230, eject the wrapped product onto the delivery chute for output.

At 1232, updating data for future predictions by feeding assembly and demand outcomes back into historical data storage.

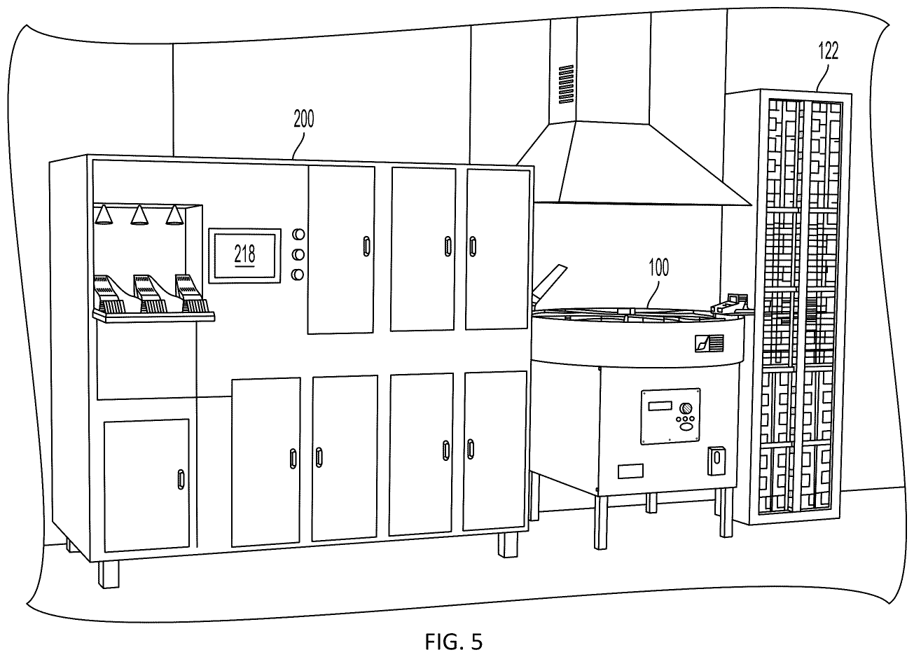

FIG. 5 depicts a perspective view of the complete automated hamburger or sandwich cooking, assembly and wrapping production line consisting of the temperature-controlled patty dispensing component 122, the automated patty cooking apparatus 100 with rotating griddle 120, and the assembly and wrapping module 200. The apparatus is housed in a compact cabinet, with the AI control module 136 and touch screen 218 integrated for operation. This overall configuration enables high-volume assembly (e.g., 180 burgers per hour) without conveyor belts, emphasizing ease of maintenance and food safety through removable components.

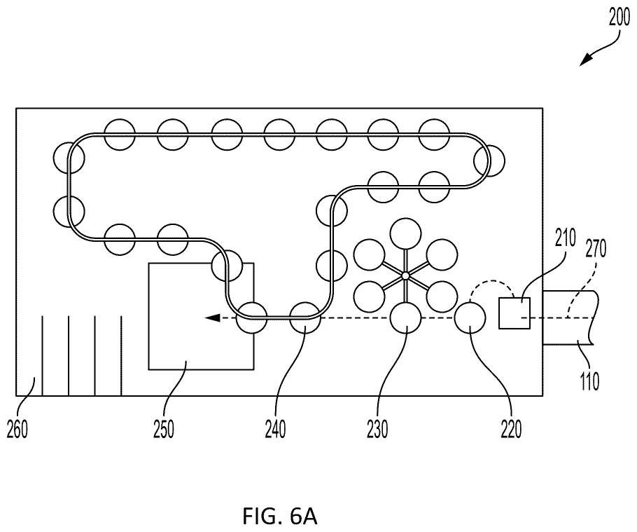

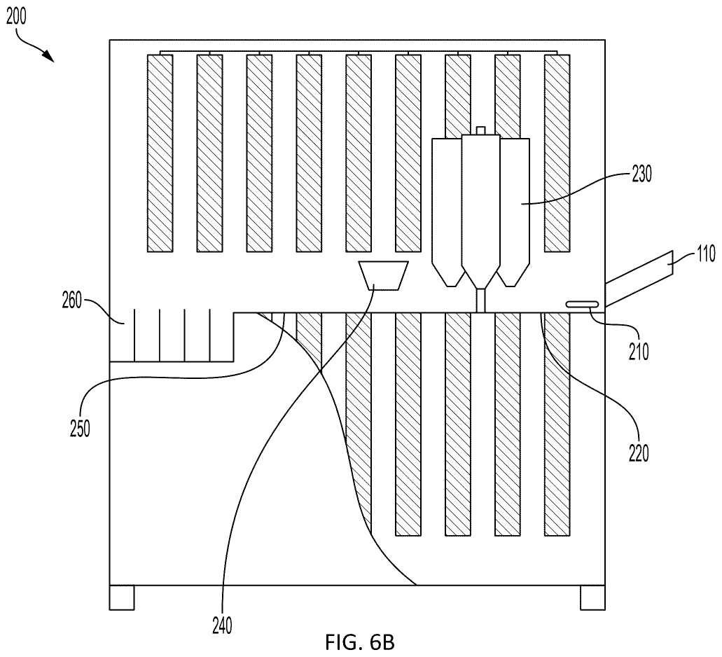

FIG. 6A depicts a top view of the assembly and wrapping module 200 showing the assembly line process to assemble and wrap a hamburger or sandwich including the lift-transfer mechanism to transfer the cooked patty onto a bottom bun 210, the next station where the bottom bun half is dispensed from below 220, the condiment hoppers mounted on a rotatable carousel at the condiment station 230, the top bun station 240 where the top half of the bun is dispensed from above, the wrapping station 250, and the delivery chute for output 260.

To complement the top plan view shown in FIG. 6A, a cross sectional front view as illustrated in FIG. 6B reveals the dual continuous loop configuration of the bun tube dispensers, comprising an upper loop for top bun halves and a lower loop for bottom bun halves, each formed as an endless conveyor (e.g., chain-driven) capable of holding and circulating multiple bun tubes without the type of overloading that would result in compression. This arrangement addresses prior art limitations, such as the capacity bottleneck in traditional hoppers that typically accommodate only about 20 bun halves per tube before risking squishing at the bottom or necessitating constant manual refilling. By enabling automated, high-volume reloading via the continuous tube loops, the system minimizes downtime, enhances throughput, and maintains bun integrity during the assembly process.

Once a cooked patty slides down the chute 110 from the automated griddle, a patty lift-transfer mechanism 210 is configured to receive a cooked patty from a discharge chute and to lift and place the patty onto a lower bun positioned on the assembly line. The patty transfer mechanism 210 may include a lifting platform, carrier, or other support configured to transfer the patty without reliance on sliding contact.

In one embodiment, the advancement of the hamburger through the assembly and wrapping module is achieved via mechanical means 270, such as a series of synchronized push rods or pneumatic actuators, which engage the product at each station to propel it forward along a guided rail or track without relying on a continuous conveyor belt. This approach eliminates the inefficiencies and maintenance requirements associated with traditional belts, such as slippage, wear, or misalignment, while ensuring precise indexing through integrated sensors (e.g., optical or proximity detectors) that confirm exact positioning before activating the next push cycle. For instance, after condiment application at the carousel station 230, a push rod extends to slide the partially assembled burger a predetermined distance to the top bun dispenser 240, halting at a stop gate or detent for alignment, thereby guaranteeing repeatable accuracy within tolerances of less than 1 mm and facilitating seamless integration with subsequent folding or wrapping operations at station 250.

To address bun dispensing bottlenecks, the bottom and top bun tubes comprise multiple parallel tubes (e.g., 18-20 per side) arranged in a continuous loop within the cabinet. Each tube holds approximately 20 stacked bun tops or bottoms, providing a total capacity of 360-400 whole buns for a minimum 2-hour buffer at 180 burgers per hour. The continuous loop is driven by a stepper motor or servo controlled by the AI module, rotates to index an empty tube away from the dispensing position and aligns a full tube. Sensors (e.g., photo eyes or load cells) detect low bun levels in the active tube, triggering automatic rotation in seconds to maintain continuous flow.

For bottom buns, the dispensing tube is positioned below the counter-height assembly station, with spring-loaded or pneumatic pushers in each tube elevating buns upward 220. For top buns, the continuous loop is mounted above, dispensing downward via gravity and solenoid gates 240. Tubes are removable and washable, with cabinet front-access doors and a designated loading zone on the loop for easy horizontal insertion of pre-stacked bun sleeves, reducing labor and refill frequency compared to prior art single-feed systems.

In an alternative embodiment, and with reference to the overhead plan view illustrated in FIG. 6A, the upper portion of the cabinet may be configured to include a plurality of independent overhead conveyor loops, rather than a single overhead loop. In one such embodiment, the cabinet includes a first overhead conveyor loop positioned toward an upstream side of the assembly line and a second overhead conveyor loop positioned toward a downstream side of the assembly line. Each overhead conveyor loop transports a respective plurality of bun containers supported above the assembly line. The first overhead conveyor loop may be configured to transport and dispense lower bun portions, while the second overhead conveyor loop may be configured to transport and dispense upper bun portions. In this configuration, lower bun portions and upper bun portions are dispensed sequentially from above the assembly line at different stations, eliminating the need for a lower bun elevator or pop-up mechanism beneath the assembly surface. Each overhead conveyor loop may include a rear circulation region, a curved bypass region configured to route around one or more stay-out zones associated with other equipment within the cabinet, and a forward presentation region accessible from a front side of the cabinet for removal, replacement, or refilling of bun containers. The overhead conveyor loops may be independently indexable and independently controllable, allowing coordinated or asynchronous operation.

In some embodiments, the available overhead volume of the cabinet is divided laterally between the first overhead conveyor loop and the second overhead conveyor loop. Although the number of bun containers carried by each loop may be reduced relative to a single-loop configuration, overall capacity may be maintained or increased by increasing the length of the bun containers, for example by increasing cabinet height to accommodate taller bun containers holding a greater number of bun portions.

In further embodiments, the first and second overhead conveyor loops may be configured with different capacities, different container sizes, or different dispensing characteristics, depending on whether the loop is configured to dispense lower bun portions or upper bun portions. The overhead conveyor loops may share common structural supports, control systems, or access openings, or may be fully independent. This alternative embodiment provides a modular overhead bun handling architecture that enables all bun portions to be supplied from above the assembly line while maintaining controlled dispensing locations, avoiding bun separation mechanisms, and preserving accessibility for refilling and maintenance.

The bun tube continuous loop system 220 and rotating condiment carousel 230 eliminate the need for conveyor belts. By using a continuous loop of bun hoppers and rotating condiment hoppers, the design enhances hygiene, simplifies maintenance, decreases the footprint length of the assembly line and solves the bun bottleneck problem by enabling high-throughput operation without interruptions.

In further detail, the cheese hopper at the condiment station 230 is configured to dispense squeezable cheese or a processed cheese product, which is stored in a viscous state suitable for automated extrusion. Condiments may be dispensed using gravity, positive displacement pumping, peristaltic pumping, augers, pressurized containers, or other known food-dispensing mechanisms to force the cheese through a nozzle or aperture onto the patty in a controlled ribbon or layer. This ensures precise portioning (e.g., 1-2 ounces per burger) and even coverage across the patty surface, promoting uniform melting and adhesion without excess runoff.

Hopper capacities are sized to support high-volume operations, such as 180 burgers per hour, with minimal refills. For squeezable cheese (non-TCS, stable at room temperature), hoppers hold 2-4 gallons (7.5-15 liters), lasting 2-4 hours at 1 oz per cheeseburger (assuming 50% orders), enabling daily refills per food safety guidelines to prevent residue buildup.

Similarly, for ketchup, mustard, and relish (all non-TCS with low pH<4.6), hoppers are 3-5 gallons (11-19 liters) each, lasting 3-5 hours at 0.5-1 oz portions, matching standard bulk pouch sizes (e.g., 1.5-5 gallon pouches with fitments for quick loading). This facilitates easy horizontal insertion via carousel access, reducing labor and contamination risks compared to prior art conveyors.

Refill frequencies comply with FDA Food Code: daily or when empty for cleaning/sanitation, with AI monitoring levels to predict and schedule during lulls. Bulk pouches ensure hygienic refills without partial transfers, solving bottlenecks in prior art by aligning with QSR supply chains for seamless, low-labor operation.

To address melting challenges, the cheese hopper incorporates a heating element, such as an embedded resistive coil or jacketed sleeve, controlled by the AI control module 136 to maintain the cheese at an optimal temperature (e.g., 100-140° F.) for viscosity and flow. This heating prevents the dispensed cheese from cooling the hot patty, unlike grated cheese systems where ambient-temperature shreds require additional patty heat for melting. The AI module monitors patty temperature via infrared sensors and adjusts hopper heat dynamically to ensure immediate melt initiation upon contact.

In one embodiment, the cheese hopper container itself is heated via the heating element integrated into its walls, allowing the squeezable cheese to remain fluid without clumping or separation. The nozzle may include adjustable apertures for varying dispense patterns (e.g., spiral or grid) based on order specifications, such as extra cheese. The hopper is removable for refilling with bulk viscous processed cheese, which is commercially available and tastes similar to traditional slices, enabling QSRs to meet consumer expectations while reducing labor and waste.

This design distinguishes from prior art grated cheese tubes, which dispense dry shreds prone to bridging (clumping in the tube) and scattering during application, leading to inconsistent amounts and potential food safety hazards from fallen particles. By using squeezable cheese, the hopper eliminates these issues, providing a hygienic, mess-free solution that integrates seamlessly into the automated assembly line. Furthermore, due to the viscous state of the cheese, much more cheese by weight can fit into the same hopper versus grated cheese resulting in fewer refills accommodating high volume throughput.

The AI control module 136 further optimizes cheese dispensing by predicting demand for cheeseburgers based on historical data (e.g., peak lunch hours) and pre-heating the hopper accordingly to minimize wait times. Sensors detect cheese level and viscosity, alerting for refills or adjustments to maintain quality.

Following the placement of the top bun onto the assembled burger via the overhead tubular hoppers 220, the burger advances to the wrapping station 250 for automated enclosure in a suitable wrapping material, such as wax paper, foil, or other food-safe sheets, to protect the product and facilitate handling. In various embodiments, the wrapping mechanism may employ techniques to position, fold, and secure the material around the burger, ensuring a complete and hygienic seal without direct human intervention. For example, in one embodiment, the mechanism may include a pair of opposing rollers to feed a continuous sheet from an overhead spool, with the sheet positioned beneath the burger conveyor path; a folding assembly, such as articulated arms or pneumatic actuators, then sequentially folds the material around the burger's perimeter by creasing lateral edges inward and overlapping the leading and trailing edges to form a secure envelope. Optional features, such as heat-sealing elements, may apply localized heat to bond the overlaps for tamper-evident packaging. To accommodate customizations, a labeling subsystem integrated into or adjacent to the wrapping station may apply adhesive labels or direct printing onto the wrapping material, indicating specific variants such as “cheeseburger,” “no ketchup,” or other order details derived from upstream order data, thereby ensuring accurate identification and customer satisfaction. Once wrapped and labeled, the completed product is gently ejected into sloped delivery chutes 260, which guide it downward via gravity to a collection area or further conveyance, minimizing handling and maintaining hygiene throughout the process.

In another embodiment, following the placement of the top bun onto the assembled burger via the overhead tubular hoppers 220, the burger advances to the wrapping station 250 configured for automated packaging using pre-formed cardboard hamburger boxes, such as clamshell-style containers made from food-safe, recyclable cardstock, to provide enhanced structural protection and branding opportunities. The mechanism may include a box dispenser that sequentially releases and opens a flat or partially assembled box onto the conveyor path, positioning it to receive the burger via a guided transfer arm or vacuum-assisted placement. Once the burger is centered within the lower half of the box, a closing assembly employing mechanical folders, pneumatic presses, or robotic arms folds and secures the upper lid, optionally engaging interlocking tabs or applying adhesive dots for a tamper-evident seal. To accommodate customizations, a labeling subsystem 251 integrated into or adjacent to the station may apply printed labels or direct inkjet marking onto the box exterior, indicating variants such as “cheeseburger,” “no ketchup,” or other order specifics derived from upstream data. The completed boxed product is then gently ejected onto sloped delivery chutes 260, which guide it downward via gravity to a collection area or further conveyance, ensuring minimal handling and optimal hygiene throughout the process.

This written description uses examples to disclose the invention, including the best mode, and also to enable any person skilled in the art to practice the invention, including making and using any devices or systems and performing any incorporated methods. The patentable scope of the invention is defined in the disclosure, and may include other examples that occur to those skilled in the art. Such other examples are intended to be within the scope of the invention if they have structural elements that do not differ from the literal language of the invention, or if they include equivalent structural elements within substantial differences from the literal language of the invention.

What is claimed is:

1. An automated food preparation apparatus, comprising:
(a) a patty cooking module including a horizontal rotating griddle (104) with dividers (120) defining up to 12 separated cooking surfaces for batch cooking of up to 12 patties, a dispensing component (106) for placing food patties between the dividers, a flipper (108) positioned on an opposite side of the griddle from the dispensing station for flipping the patties, and a chute slide (110) for delivering cooked patties;
(b) an assembly and wrapping module operatively coupled to the patty cooking module, including a lift/transfer mechanism (210) to position the cooked patty onto a bottom bun, a condiment station with a rotating carousel (220), tubular hoppers (240) for dispensing a top bun, a wrapping station (250), and mechanical advancing means to move the assembled product between stations; and
(c) wherein the AI control module (136) implements variable rotational speeds for a first cooking stage of approximately 1.5 rotations in about 2 minutes and a second stage of approximately 1.0 rotation in about 2 minutes, with batch sizes reduced during off-peak periods, and the apparatus is configurable as a linear production line maintaining up to 180 2 oz. patties per hour throughput.

2. The apparatus of claim 1, further comprising an AI control module (136) configured to optimize variable rotational speed of the griddle based on temperature sensors and order data, including asymmetric stage adjustments due to flipper position.

3. The apparatus of claim 1, wherein the dispensing component (106) includes stacked horizontal trays (106a) in a tower tray holder (122) and an actuated push component (124) for dispensing patties onto the griddle.

4. The apparatus of claim 1, wherein the flipper (108) is attached to the chute slide (110) and capable of bidirectional movement.

5. The apparatus of claim 1, wherein the lift/transfer mechanism (210) elevates and transfers the cooked patty from the chute slide (110) to the bottom bun dispensed from a lower continuous loop (220).

6. The apparatus of claim 1, wherein the rotating carousel (230) is mounted on a vertical shaft and dispenses condiments sequentially over the assembly line.

7. The apparatus of claim 1, wherein the tubular hoppers (240) are attached to an overhead-mounted continuous loop conveyor for top bun dispensing.

8. The apparatus of claim 1, wherein the wrapping station (250) includes a mechanism for enclosing the assembled product in wrapping material or a cardboard box.

9. The apparatus of claim 8, further comprising a labeling subsystem (251) for applying labels indicating customizations based on order data.

10. The apparatus of claim 1, wherein the mechanical advancing means (270) comprises synchronized push rods or pneumatic actuators with positioning sensors (280) for precise indexing.

11. The apparatus of claim 1, further comprising sloped delivery chutes (260) for gravity-assisted output of the wrapped product.

12. The apparatus of claim 1, further comprising an interface for receiving orders (1202), a switch button (114) for initiating operation, and a touchscreen user interface (218).

13. A method for automated food preparation, comprising:
a) receiving an order via a user interface;
b) dispensing food patties onto a horizontal rotating griddle (104) between dividers (120);
c) cooking the patties while monitoring temperature with sensors linked to an AI control module (136) using variable speeds for a first stage of 1.5 rotations (˜2 min) and second stage of 1.0 rotation (˜2 min), in batches of up to 12 patties;
d) flipping the patties using a flipper (108) on the opposite side;
e) delivering the cooked patties via a chute slide (110) to an assembly module;
f) transferring the patty onto a bottom bun using a lift/transfer mechanism (210);
g) advancing the assembly to a condiment station for dispensing via a rotating carousel (230);
h) dispensing a top bun from tubular hoppers (240); and
i) wrapping the assembled product at a wrapping station (250); and dispensing the wrapped product via sloped delivery chutes (260) wherein the variable speeds enable reconfiguration as a linear line at up to 180 2 oz. patties per hour.

14. The method of claim 13, further comprising stacking horizontal trays (106a) in a tower tray holder (122) and pushing patties onto the griddle using an actuated push component (124).

15. The method of claim 13, wherein the AI control module (136) adjusts griddle speed and heating based on detected patty temperature.

16. The method of claim 13, wherein advancing the assembly uses mechanical means (270) with sensors (280) for precise positioning.

17. The method of claim 13, wherein wrapping includes folding material around the product and optionally heat-sealing.

18. The method of claim 13, further comprising applying a label via a labeling subsystem (251) indicating order customizations.

19. The method of claim 13, wherein bottom buns are dispensed from a lower continuous loop and top buns from an overhead loop to address capacity bottlenecks.

20. The apparatus of claim 1, wherein the assembly and wrapping module eliminates a conveyor belt in favor of the mechanical advancing means (270).

21. The apparatus of claim 1, further comprising sensors for checking bun levels and triggering carousel rotation for replenishment.

22. The method of claim 13, further comprising performing AI/sensor checks for bun levels and rotating carousels if empty before dispensing.

23. The apparatus of claim 1, integrated with a server (130), processor (134), and cloud assessing component (132) for data-driven optimization.

24. The method of claim 13, wherein the process is extended to include block diagram-controlled coordination between cooking and assembly via the AI control module (136).

25. The apparatus of claim 1, wherein components are removable and washable for hygiene maintenance.
